(19) United States
(12) Patent Application Publication
(10) Pub. No.: US 2004/0088310 A1
(43) Pub. Date: May 6, 2004

(54) Recording medium, recording apparatus, recording method, reproduction apparatus and reproduction method

(75) Inventors: Naozumi Sugimura, Yokohama (JP); Masuo Oku, Kamakura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/688,415

(22) Filed: Oct. 17, 2003

(30) Foreign Application Priority Data
Oct. 18, 2002 (JP) 2002-303720

(51) Int. Cl. G06F 17/00

(52) U.S. Cl. 707/100

(57) ABSTRACT

If a program list prescribing an order to reproduce video and audio data is recorded in a binary-data format, a low affinity with a text-format language such as the XML results. For this reason, the program list is recorded as a file with a text format in addition to a file having the conventional binary-data format

### BACKGROUND OF THE INVENTION

The present invention relates to a recording medium used for recording data and a data-recording/reproduction technology using the recording medium.

A data-recording/reproduction technology using DVD (Digital Versatile Discs) represented by a digital video disc has been put to practical use. In a digital video apparatus, video and audio data are subjected to a digital compression and encoding process using a digital picture compression technology such as an MPEG (Moving Picture Expert Group)-2 technique before being recorded onto a digital disc serving as a recording medium for later reproduction.

The video/audio data is recorded on a medium such as a digital video disc as files, which can be managed in units each referred to as a program. A reproduction list of the programs is also stored on the recording medium along with the video/audio data as a data file known as a program list. JP-A Nos. 2002-152665 and 2002-369138 disclose technologies for recording management information used for managing video/audio data such as program lists on recording media.

By using a program list, it is possible to carry out reproduction operations including detection of the head of a program and to skip with ease. A program list is modified when the user carries out works such as operations to record, delete and edit a program. Every time a program list is modified, the modified program list is recorded on the recording medium. In the case of a reproduction-only digital video disc used for recording video such as movies, a program list made in advance is also recorded on the same disc.

Data on a program list is recorded as pieces of binary data, which each has a predetermined length. For example, the number of program items is represented by a number having a length of 16 bits and a reproduction start time is represented by a number having a length of 32 bits.

### BRIEF SUMMARY OF THE INVENTION

Such a recording medium has the following problems. A program list has a data structure comprising a predetermined number of bits and is recorded on a recording medium as a binary-data file. Binary data does not have a meaning like a character. Thus, the program list cannot be analyzed as a text file.

In a network environment using a database, the Internet and other resources, conversely, a descriptive language based on texts (character strings) referred to as HTML (Hyper Text Markup Language) and the XML (eXtensible Markup Language) is generally used. A personal computer and an Internet environment are not capable of recognizing control data using traditional codes such as binary codes. Thus, if utilization in a network environment is taken into consideration, it is desirable to use a text-based file rather than a binary-data file.

If a program list to be recorded on a recording medium is all treated as a text-based data file, however, compatibility with the conventional digital video apparatuses is inevitably lost so that it is no longer possible to reproduce video/audio data.

This invention addresses the problems described above to provide a data-recording/reproduction technology capable of recording and reproducing data while sustaining compatibility with conventional apparatuses even if a network environment such as the Internet is used.

To solve the problems described above, according to one aspect of the present invention, a program list prescribing an order of reproducing data is made in text and non-text forms and program lists in text and non-text forms are each recorded on the same recording medium.

### BRIEF DESCRIPTION OF THE DRAWINGS

FIG. 1 is a block diagram showing an embodiment implementing a data-recording/reproduction apparatus, to which the present invention is applied;

FIG. 2 is a diagram showing a program list described in a binary-data format;

FIG. 3 is a diagram showing the length of each item on the program list shown in FIG. 2;

FIG. 4 is a diagram showing a program list described in a text format;

FIG. 5 is a block diagram showing the system configuration of a data-recording/reproduction apparatus shown in FIG. 1 when used in a network environment; and

FIG. 6 is a diagram showing a model of tasks executed by a control microcomputer employed in a data-recording/reproduction apparatus shown in FIG. 1 when used in a network environment.

### DETAILED DESCRIPTION OF THE INVENTION

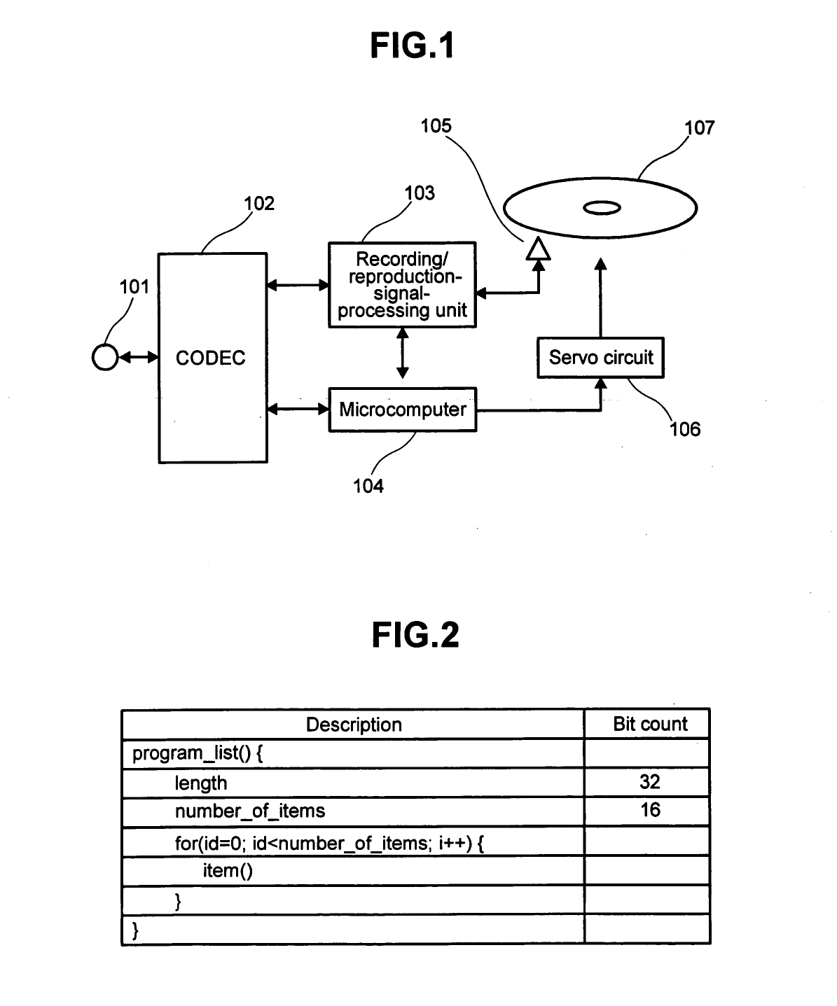

FIG. 1 is a block diagram showing an embodiment implementing a data-recording/reproduction apparatus, to which the present invention is applied. A compression/decompression circuit (CODEC) 102 converts video and audio data supplied to an input terminal 101 into a digital signal and then carries out a digital compression process on the digital signal to convert the signal into a predetermined compressed digital signal. The compression/decompression circuit (CODEC) 102 carries out the digital compression process by typically using a digital compression technique such as the MPEG technique.

A recording/reproduction-signal-processing unit 103 carries out a predetermined modulation process on the compressed digital signal and a program list made by a control microcomputer 104 to convert them into a signal that can be recorded onto an optical disc 107. By using the signal output by recording/reproduction-signal-processing unit 103 as a base, a light ray generated by an optical pickup 105 is radiated to optical disc 107 to record video and audio data conveyed by the signal. In the conversion process, recording/reproduction- signal-processing unit 103 adds predetermined error correction codes and rearranges data in order to reduce the number of read errors caused by an injury inflicted or dust stuck on optical disc 107.

In an operation to record the compressed digital signal and the program list on optical disc 107, control microcomputer 104 controls a servo circuit 106 to move the position of optical pickup 105 and controls the rotation phase of optical disc 107. The control executed by control microcomputer 104 causes the laser light ray to be radiated to a predetermined position on optical disc 107, allowing the signal to be written into a specified sector. The compressed digital signal is recorded on a plurality of sectors.

Logically, the compressed digital signal is stored in a file with a predetermined name. The name of the file is cataloged in a file management information area on optical disc 107 along with information about the locations of the sectors. In this way, the compressed digital signal can be treated as a file.

As the operation to record a program such as a TV program or a photographing scene ends, the recorded video/audio data is added to a program list as a program item. Information about a program item includes the name of the file containing the data, an encoding format and a recording time.

Control microcomputer 104 makes a program list both in the binary-data format and in a text format. A newly made program list is stored on optical disc 107 to replace an existing program list.

That is, when a program is recorded, a program item for the program is added to the program list. When a program is erased, the program item for that program is deleted from the program list. In addition, when rearrangement and/or editing processes are carried out, the contents of affected program items on the program list and/or the number of program items on the list change too. Control microcomputer 104 makes the changes to the contents of the program list.

It is to be noted that, in a reproduction process, program items on the program list are sequentially reproduced in the order the program items are cataloged on the program list. When a user presses a skip button, the reproduction process jumps to the next program item.

FIG. 2 is a diagram showing a program list described in a binary-data format. The program list includes a program-list information length 201 a program-item count 202 and information 203 included in each of the program items. The program-list information length 201 has a length of 32 bits and the program-item count 202 has a length of 16 bits.

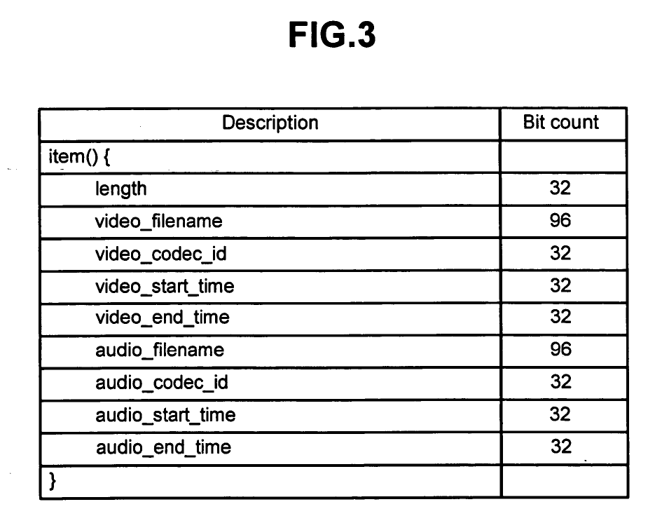

FIG. 3 is a diagram showing the actual configuration of the information 203 included in each of the program items. Each program item 203 includes an item information length 301, a video information file name 302, a video encoding technique 303, a video start time 304, a video end time 305, an audio video information file name 306, an audio encoding technique 307, an audio start time 308 and an audio end time 309.

The program list shown in FIG. 2 is composed of binary data having a predetermined length. For example, the number of program items is represented by data of 16 bits. Such data cannot be treated as a markup language such as XML.

For example, assume that the number of program items is 18. In this case, on a program list having a binary-data format as shown in FIG. 2, the number of program items is 0012h where the suffix h indicates that the number 0012 is a hexadecimal number. If this number is treated like character codes each having a length of 8 bits, the number is interpreted as 8-bit characters of 00h and 12h, which do not have a meaning like a character. Thus, the number 0012h cannot be used as a text-based descriptive language. For this reason, when treating the program list like a program list having a text format, it is necessary to convert the number 0012h into a character code of ‘18’. Accordingly, in order to easily use data recorded on use optical disc 107, write an application program or the like and use them in a network environment, it is desirable to have the program list stored in advance on optical disc 107 in text format.

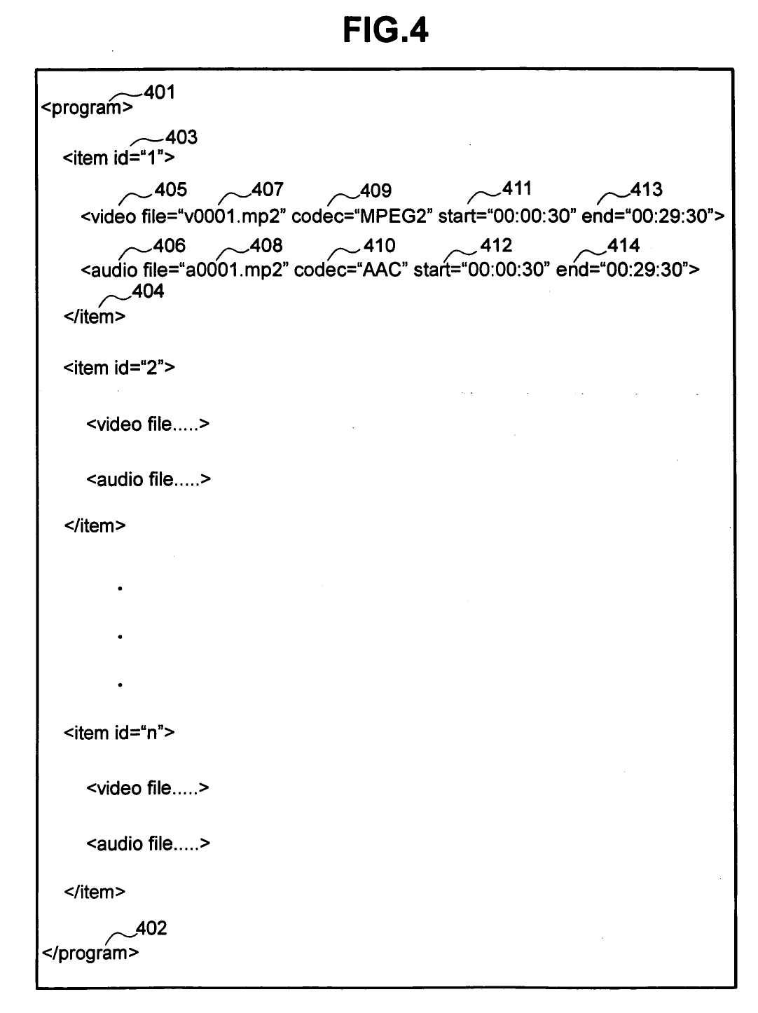

FIG. 4 is a diagram showing a program list described in a text format. On this program list, the portion between <program> 401 and </program> 402 is a program. The portion between <item> 403 and </item> 404 is a program item. This program item corresponds to program item 203 shown in FIG. 2. Each program item has a number added thereto such as id=“1”. This number is used to identify the program item to which the number is added. <video - - - > 405 in the program item shows the contents of a video program and <audio - - - > 406 in the program item shows the contents of an audio program. The contents of a video program include a file name 407, an encoding format 409, a start time 411 and an end time 413. By the same token, the contents of an audio program include a file name 408, an encoding format 410, a start time 412 and an end time 414. This file list is recorded on optical disc 107 as a data file.

When an application program is written or a network environment is used, the program list with a text format is analyzed and, by acquiring data from the list, the contents of the list can be understood with ease. In addition, since optical disc 107 is used for storing both a program list having a binary-data format and a program list having a text format, a conventional reproduction apparatus is capable of reproducing video and audio data by using the program list having a binary-data format. As a result, compatibility with the conventional reproduction apparatuses is maintained.

As described above, the embodiment is explained by focusing the description on only one program list. It is to be noted, however, that the present invention is not limited to such a scheme. If a program comprising a plurality of different series is recorded, a program list is made for each of the series. By making a plurality of program lists as such, the program can be managed with ease.

In addition, by separating a program list, which is obtained as a result of editing carried out by a user, from the original program list, each user may enjoy programs in a reproduction order desired by the user. That is, a customized program list is available for each user.

If a plurality of program lists each having a binary-data format exists, a plurality of text-formatted program lists corresponding to the respective program lists each having a binary-data format can be prepared. In this way, benefits can be derived from merits offered by the embodiment.

In addition, in the embodiment described above, compressed video and audio signals are managed as separate files. However, the present invention is not limited to such management. For example, it is also possible to similarly treat the compressed video and audio signals by adoption of a system such as an MPEG-TS (Transport System) whereby the compressed video and audio signals are converted into packets each having a predetermined length. The packets are multiplexed with each other then transmitted and/or recorded.

It is to be noted that the optical disc provided by the present invention is also used for recording a program list having a binary-data format as well as for a program list having a text format. It is quite within the bounds of possibility, however, that the contents of the program list having a binary-data format may be different from the contents of the program list having a text format for various reasons. For example, a difference in contents between the program list having a binary-data format and the program list having a text format is caused by the fact that the program list having a text format has been edited by the user or the fact that the editing work has been carried out by using an old-type player not compatible with the program list having a text format. In such a case, control microcomputer 104 compares the updating dates of both the files and updates the contents of the file with an earlier updating date on the assumption that the contents of the file with a later updating date are correct. Of course, the user can be warned of a discrepancy in contents between files and can be requested to take an action regarding the discrepancy.

The following description explains another embodiment using an optical disc, which is used for recording a program list in accordance with the embodiment described above, and a network environment.

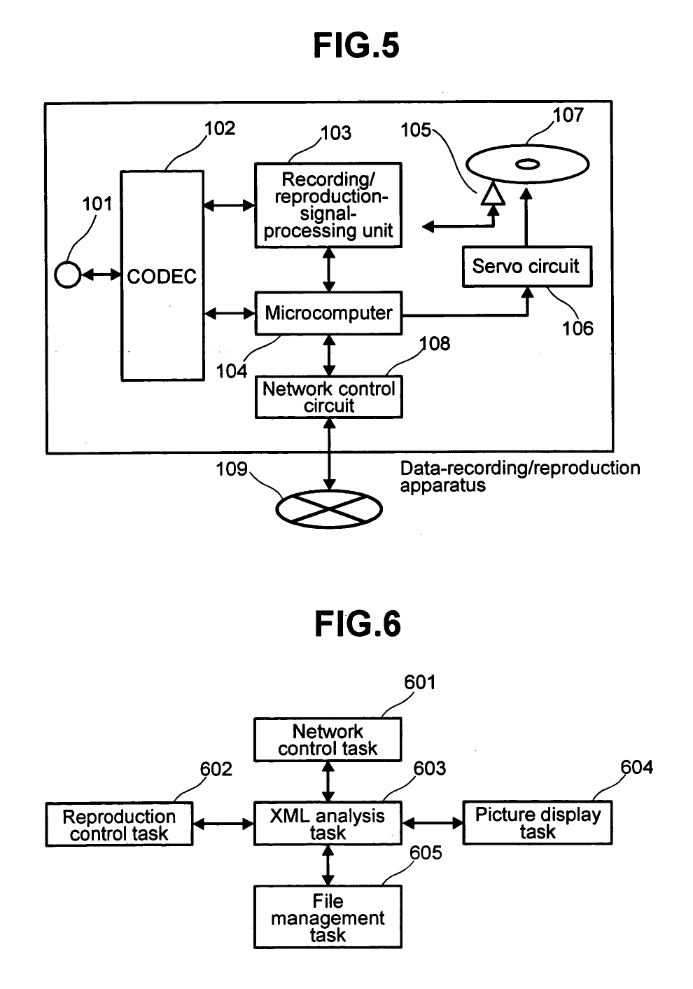

FIG. 5 is a block diagram showing the system configuration of a data-recording/reproduction apparatus connected to a network environment. In FIG. 5, reference numeral 108 denotes a network control circuit and reference numeral 109 denotes a network. Any other block denoted by the same reference numeral as its counterpart shown in FIG. 1 has the same function as the counterpart and the explanation of such blocks is not repeated.

The data-recording/reproduction apparatus shown in FIG. 5 has an additional network connection function allowing the data-recording/reproduction apparatus to exchange data with a server and another reproduction apparatus over network 109.

By using an apparatus including the network connection function, a variety of applications become possible. Examples of the application are acquisition of information on new movies and an application for mail-order businesses.

Take a shopping catalog used in mail ordering as an example. The shopping catalog shows information such as the price and inventory of a commodity, as well as other marketable goods. It is necessary to store the information in a server of a mail-order company because the information is updated daily. In addition, if a description and a simple picture of a commodity are also stored in the server, it will be easy to update them. However, image information such as information to explain a commodity by using a moving picture has a large amount of data. Thus, such information is not appropriate for transmission over a network. In order to solve this problem, image information such as a moving picture is recorded onto an optical disc in advance. Then, by combining the image information recorded on the optical disc with information stored in a server of a mail-order company, the user is able to view the most recent information on mail ordering in the data-recording/reproduction apparatus.

The technique described above can be applied to information about a movie as well. More precisely, the images of the moving picture themselves are recorded on an optical disc in advance whereas information about the theaters currently showing the movie, an explanation of newly produced movies and simple pictures are stored in a server managed by the movie company. In this way, by using a data-recording/reproduction apparatus, the user is able to view the most recent information about the movies as well as to enjoy images representing a movie.

The following description explains operations carried out by using the data-recording/reproduction apparatus shown in FIG. 5 to display a screen obtained as a result of combining information stored in a server as described above with information recorded on an optical disc.

FIG. 6 is a diagram showing a model of software tasks executed by control microcomputer 104 employed in the data-recording/reproduction apparatus implemented by the embodiment. The software is thus executed by control microcomputer 104. Reference numerals 601, 602, 603, 604 and 605 denote a network control task, a reproduction control task, an XML analysis task, a screen display task and a file management task respectively.

Network control task 601 acquires a file specified by a URL from the network and passes the contents of the file to XML analysis task 603. Network control task 601 in its running state controls network control circuit 108.

Reproduction control task 602 reproduces image information and sound information from optical disc 107 by receiving information necessary for the reproduction process as parameters. The information includes the name of a file to be reproduced as well as reproduction start and end times. In the reproduction process, reproduction control task 602 reads a signal from optical disc 107 and decodes data conveyed by the signal by controlling hardware necessary for the process. The hardware includes servo circuit 106, recording/reproduction-signal-processing unit 103 and CODEC 102.

XML analysis task 603 analyzes the contents of a file and a play list recorded on optical disc 107 in the XML format as well as the contents of an XML-formatted file acquired from network 109 and carries out a process in accordance with the contents.

Screen display task 604 displays characters and figures on a screen in accordance with a command received from XML analysis task 603. Specifically, the process of displaying characters and figures on a screen is carried out by writing data of the characters and the figures into a screen display memory employed in the CODEC 102.

File management task 605 manages files recorded on optical disc 107 and retrieves the files from optical disc 107. In order to retrieve a file from optical disc 107, file management task 605 controls servo circuit 106 and recording/reproduction-signal-processing unit 103.

When the process to reproduce information from optical disc 107 is started, control microcomputer 104 retrieves a predetermined display information file to be read initially from optical disc 107 and begins to analyze the contents of the file. More precisely, file management task 605 is executed to retrieve the specified display information file from optical disc 107 and to pass the file to XML analysis task 603.

The XML analysis task 603 analyzes the contents of the retrieved display information file and carries out processing such as the reproduction process, a network connection process and a picture-displaying process in accordance with the contents.

First, XML analysis task 603 analyzes a character display instruction in the XML. If the character display instruction is found to be an instruction to display characters, information included in the instruction is interpreted. The information includes character codes, a font shape and character formatting data. Then, recording/reproduction-signal-processing unit 103 reproduces character data as graphically formatted data in accordance with the information. The graphically formatted data reproduced by the character display instruction is written into the screen display memory employed in CODEC 102. Font information used to convert character information into graphical data may be stored in advance in a ROM (Read-Only Memory) connected to control microcomputer 104 or prerecorded on optical disc 107. If necessary, the font information is read from the ROM or optical disc 107. The font information may also be pre-stored in a server connected to network 109 to be downloaded to the data-recording/reproduction apparatus by way of network 109.

If the display information file includes a figure (graphic) display instruction, graphical information is read from optical disc 107 and written into the screen display memory. The graphical information has been stored in optical disc 107 as a file.

Moreover, it is also not always necessary to store graphical information on optical disc 107. That is, graphical information may also be stored as a file in a server connected to network 109. If graphical information is stored as a file in a server connected to network 109, the file is specified by a URL (Unified Resource Locator), which is also recorded on optical disc 107, in a format including the name of the server and the name of the directory including the file. Network control task 601 acquires the file from the server over network 109 by using the URL.

The display information file retrieved from optical disc 107 also includes an image reproduction instruction besides a picture display instruction. The image reproduction instruction specifies a play-list file as an object to be reproduced. If the display information file includes an image reproduction instruction, XML analysis task 603 informs file management task 605 of the name of the play-list file in order to support an operation to be carried out by file management task 605 to retrieve the file from optical disc 107. The name of the play-list file is specified in the image reproduction instruction. Receiving the name of the play-list file, file management task 605 retrieves the play-list file from optical disc 107 and supplies the file to XML analysis task 603.

The play-list file is recorded on optical disc 107 in advance in a text format like the one shown in FIG. 4. Thus, XML analysis task 603 is capable of using the play-list file retrieved from optical disc 107 as it is. Then, XML analysis task 603 analyzes the play-list file retrieved from optical disc 107 in order to acquire parameters such as the name of a file, a reproduction start time and a reproduction end time for each play item on a play list stored in the play-list file. XML analysis task 603 then supplies the parameters such as the name of a file, a reproduction start time and a reproduction end time to reproduction control task 602.

Reproduction control task 602 retrieves the file indicated by the name from optical disc 107 and reproduces images and sounds for a period of time between the reproduction start time and the reproduction end time.

At that time, characters displayed in accordance with the character display instruction, figures displayed in accordance with the figure display instruction, images displayed in accordance with the image display instruction and other information are synthesized and the result of the synthesis is displayed on an external monitor screen by way of an output terminal.

Note that network control task 601 acquires information described in a shopping catalog, information about theaters showing movies, an explanation describing a newly produced movie and a simple picture such as data of files, whereas XML analysis task 603 and screen display task 604 are executed to display the data on an external monitor screen. As described above, examples of the information described in a shopping catalog include the prices and inventories of commodities, marketable goods, descriptions and simple pictures of commodities.

As described above, in accordance with the data-recording/reproduction apparatus implemented by this embodiment, a play list is also recorded on optical disc 107 as information having a text format. Thus, XML analysis task 603 is easily capable of analyzing a play list as part of the data having the XML format. As a result, it is possible to display characters and figures as well as to reproduce a specified movie. As described above, the characters and figures are included in a display information file.

In addition, it is also possible to transmit and receive information such as a play list described in text format over network 109 and, hence, treat the information in the same way as data exchanged through network 109. As a result, a play list can be exchanged with ease with a server or another reproduction apparatus over network 109 provided that the server or the other reproduction apparatus is connected to the network 109.

For example, a method is conceived whereby a newly made play list, separate from the play list recorded on optical disc 107, is stored in a server connected to network 109 and downloaded to the data-recording/reproduction apparatus by way of network 109 to be used in a reproduction process. By adoption of this method, it is possible to carry out a reproduction process after later addition of an arranged movie title to, for example, an uncensored version or a director's cut version separately from a movie title of a theater version already recorded on the conventional disc. In this case, since it is necessary to download the new play list from the server over network 109, it is desirable to present the play list in a text format.

It is possible to download a play list from the server over network 109 and to carry out a reproduction process based on the play list by following the procedure described next. First, control microcomputer 104 starts an operation to download a file containing a play list from a predetermined server over network 109 at a request made by the user. Specifically, network control task 601 is activated to drive network control circuit 108 to access the server connected to network 109. Network control circuit 108 downloads a file containing the play list from the server over network 109 and supplies the file to XML analysis task 603. XML analysis task 603 then uses the downloaded file containing the play list to reproduce a stream from optical disc 107.

The play-list file downloaded from the server over network 109 is a file having a text format, as is the case with a pay-list file recorded on optical disc 107 in advance. Thus, it is possible to deal with network 109 with ease without a need to convert the data of the downloaded play list into data of a text format.

Conversely, there is also a conceivable case in which a play list is output to another apparatus connected to network 109. For example, a user holding a portable terminal wants to refer to a play list recorded on the data-recording/reproduction apparatus located at home by connecting the terminal to the data-recording/reproduction apparatus through network 109. In this case, the data-recording/reproduction apparatus transmits the play list to the portable terminal over network 109.

First of all, the user operates the portable terminal to establish a connection with the data-recording/reproduction apparatus on network 109. In this case, a predetermined process is carried out to authenticate the portable terminal by using information such as a user name and a password. That is, control is executed so that only an authorized user is allowed to access the data-recording/reproduction apparatus using the portable terminal. Of course, since the identification number (ID) of the portable terminal has been registered in the data-recording/reproduction apparatus in advance, an illegal access can be avoided.

The data-recording/reproduction apparatus receives a command from the portable terminal over network 109 and carries out an operation in accordance with the command. More precisely, first, the user enters a play-list transmission command to the portable terminal. Then, the portable terminal transmits the play-list transmission command to network control circuit 108 over network 109. Subsequently, network control circuit 108 receives play-list transmission command and passes the command to control microcomputer 104. Receiving the play-list transmission command, control microcomputer 104 retrieves a file containing the play list from optical disc 107 and transmits the file to the portable terminal carried by the user over network control circuit 108 and network 109.

The portable terminal held by the user processes the contents of the received play-list file to produce play-list data in a form that can be understood by the user and then displays the data. At that time, since the play list has been described in the file in a text format, the file can be easily transmitted from network control circuit 108 to the portable terminal over network 109 and processed in the terminal with ease. As described above, by handling a play-list file as a file having a text format, the affinity with network 109 can be enhanced and a program for processing a display control language such as the XML or the HTML is capable of analyzing the file with ease.

What is claimed is:

1. A recording medium used for recording information, comprising:
a first program list prescribing an order to reproduce data; and
a second program list prescribing the same order to reproduce data as said first program list in a file format different from said first program list.

2. A recording medium according to claim 1, wherein said first program list is a list written in a text format and said second program list is a list written in a non-text format.

3. A recording apparatus for recording data onto a recording medium, comprising:
an optical pickup for radiating a light ray to said recording medium; and
a control microcomputer for controlling said recording apparatus,
wherein said control microcomputer controls an operation to record a first program list prescribing an order to reproduce data and a second program list prescribing the same order to reproduce data as said first program list in a file format different from said first program list onto said recording medium by using said optical pickup.

4. A recording apparatus according to claim 3, wherein said first program list is a list written in a text format and said second program list is a list written in a non-text format.

5. A recording method for recording data onto a recording medium, comprising the steps of:
recording a first program list prescribing an order to reproduce data onto said recording medium; and
recording a second program list prescribing the same order to reproduce data as said first program list in a file format different from said first program list onto said recording medium.

6. A recording method according to claim 5, wherein said first program list is a list written in a text format and said second program list is a list written in a non-text format.

7. A reproduction apparatus for reproducing data from a recording medium, comprising:
an optical pickup for radiating a light ray to said recording medium; and
a control microcomputer for controlling said reproducing apparatus,
wherein said control microcomputer controls an operation to reproduce
a first program list prescribing an order to reproduce data or a second program list prescribing the same order to reproduce data as said first program list in a file format different from said first program list by using said optical pickup from said recording medium used for recording said first and second program lists.

8. A reproduction apparatus according to claim 7, wherein said first program list is a list written in a text format and said second program list is a list written in a non-text format.

9. A reproduction method for reproducing data from a recording medium, comprising the steps of:
radiating a light ray to said recording medium; and
detecting said radiated light ray reflected from said recording medium; and
reproducing a first program list prescribing an order to reproduce data or a second program list prescribing the same order to reproduce data as said first program list in a file format different from said first program list from said recording medium used for recording said first and second program lists.

10. A reproduction method according to claim 9, wherein said first program list is a list written in a text format and said second program list is a list written in a non-text format.
